(19) United States
(12) Patent Application Publication
(10) Pub. No.: US 2006/0279136 A1
(43) Pub. Date: Dec. 14, 2006

(54) Optimally configured control device for a motor vehicle parking brake

(75) Inventors: Alexander Haeussler, Kornwestheim (DE); Heiner Messner, Kornwestheim (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/558,810

(22) PCT Filed: May 15, 2004
(86) PCT No.: PCT/DE04/01028

§ 371 Date: Aug. 21, 2006

(30) Foreign Application Priority Data
Jun. 2, 2003 (DE) 103 24 808.0

(51) Int. Cl. B60T 13/00

(52) U.S. Cl. 303/20; 303/113.1

(57) ABSTRACT

An electrically triggered parking brake system for motor vehicles includes an operating element for actuating the parking brake system and at least one control unit which triggers an actuator of the parking brake system in response to actuation of the operating element. A configuration of the parking brake system includes one control unit which is arranged such that it is able to trigger both an actuator for actuating a wheel brake and an actuator for arresting the wheel brake.

### FIELD OF THE INVENTION

The present invention relates to an electrically triggered parking brake system for motor vehicles.

### BACKGROUND INFORMATION

Parking brake systems are used in particular to prevent a parked vehicle from rolling away. In so doing, according to statutory regulations, the brake must be mechanically locked and must immobilize the vehicle in energy-free fashion. Modern, electrically triggered parking brake systems include essentially two functionalities. First of all, a hold function (AVH: automatic vehicle hold function), in which the wheel brakes are actuated by triggering of a control unit, may be carried out by manipulation of an operating element (push button) or automatically. This may be done, for example, in driving situations such as starting from rest on a hill, etc., in order to hold the vehicle for a short period. Secondly, the wheel brakes can be locked by triggering an arresting device, in order to hold the vehicle in energy-less fashion when, for example, it is to be parked long-term.

FIG. 1 illustrates a configuration of a conventional parking brake system 11. Parking brake system 11 includes a hydraulic brake system 4, 5, 13 which is triggered by a first control unit 10 in order to perform hold function AVH, and an electromechanical arresting device 3, 12 which is triggered by a second control unit 9 in order to lock wheel brake 5 in energy-less fashion. Arresting device 3, 12 may be an electromotor, for example, which locks or releases wheel brake 5 by actuation of an arresting element. The hydraulic brake system includes a hydraulic unit 4 having at least one hydraulic pump and valves (not shown), as is conventional, for example, from ESP applications, as well as a hydraulic line 13 that discharges at wheel brake 5.

In this system, control units 9, 10 are configured such that control unit 9 functions as master control unit, and control unit 10 functions as slave control unit. That is to say, in response to an actuation of operating element 1, control unit 9 outputs control signals, e.g., in the form of an AVH-activation bit (AVH-AB) and AVH-setpoint pressure (Pₛₒ), to control unit 10 which, as slave, carries out hold function (AVH) by triggering hydraulic unit 4 accordingly and setting the desired setpoint pressure. The status of hold function AVH, such as active/not active, availability, pressure, etc., is transmitted (signal AVHₛₜₐₜᵤₛ) back to control unit 9 via interface S. Slave control unit 10 thereby indicates to master control unit 9 the implementation of the demand and the availability of hold function AVH.

Control unit 10 is usually a control unit for executing an electronic stability program (ESP), and control unit 9 is a control unit for performing an arresting function (EMP: electromechanical parking brake) for the parking brake system.

As a rule, master control unit 9 causes the implementation of hold function AVH, without necessarily also activating the arresting function EMP. Only under given conditions, such as, for example, upon switching off the engine or when the driver leaves the vehicle, does control unit 9 trigger arresting device 3, 12 to lock or release brake 5.

From suitable sensors, EMP control unit 9 receives all information about the operating state of the vehicle, such as information about the combustion engine, the driver's acceleration or braking intent, the driver's seat occupancy, the vehicle speed or acceleration, etc., which is necessary for carrying out the “standstill management”, i.e., for carrying out hold function AVH and arresting function EMP.

The configuration and communication of control units 9, 10 shown in FIG. 1 are relatively costly and require a relatively complex interface S. Moreover, the data for AVH setpoint pressure Pₛₒ must be adapted individually to ESP control unit 10 used in each case.

### SUMMARY

An example embodiment of the present invention may simplify the control-unit configuration of a parking brake system.

According to an example embodiment of the present invention, instead of using two control units, only one control unit is used, and is arranged such that it is able to trigger both an actuator for actuating the wheel brake (e.g., a hydraulic pump) and an actuator for arresting the wheel brake (e.g., an electromotor). The control unit may thus be used simultaneously for carrying out the hold function (AVH) and the arresting function (EMP). It may thereby be possible to realize the parking brake system in a particularly simple manner.

The indicated functions may be implemented in the vehicle control unit which also executes an electronic stability program (ESP). This may provide that most of the information about the driving condition of the vehicle may be taken over from the electronic stability program system, and may not have to be supplied to a second control unit.

The control unit may form one structural unit, to which the operating element of the parking brake system is connected.

When working with a parking brake system whose hold function and arresting function are carried out by two different control units, the hold function may be carried out automatically using the control unit which triggers the actuator of the wheel brake, and this control unit may be used as master control unit, this control unit also triggering the second control unit for carrying out the arresting function. The first control unit which triggers the actuator of the wheel brake functions as master control unit, and the second control unit which triggers an actuator of the arresting device functions as slave control unit. The allocation is therefore interchanged compared to the conventional system described above. In particular, this may provide that no setpoint-pressure data or setpoint-torque data have to be transmitted via the communication interface between the control units, and it is therefore possible to use a standard interface. Moreover, this configuration may be realized regardless of the control element, i.e., regardless of the ESP control unit used.

The first control unit for triggering the wheel brake may be at the same time also the ESP control unit for executing an electronic stability program. If further functions, such as ACC (adaptive cruise control) or TJA (traffic jam assist), are also implemented in this control unit, the hold and arresting functions (AVH and EMP) of the parking brake system may also be used by these program modules.

All information about the vehicle operating state necessary for carrying out hold function (AVH) may be supplied to the first (master) control unit. At least data about the operating state of the combustion engine and/or about the occupancy of the driver's seat may be supplied by a suitable sensor suite to the second (slave) control unit for triggering the arresting device.

The functionality of the first and second control units may also be integrated in a single control unit. The communication interface is only located within the control unit.

Example embodiments of the present invention are explained in more detail below with reference to the appended Figures.

### BRIEF DESCRIPTION OF THE DRAWINGS

FIG. 1 illustrates a conventional electrically triggered parking brake system having a control-unit.

FIG. 2 illustrates an electrically triggered parking brake system having a single universal control unit according to an example embodiment of the present invention.

FIG. 3 illustrates a parking brake system having a control-unit configuration according to an example embodiment of the present invention.

### DETAILED DESCRIPTION

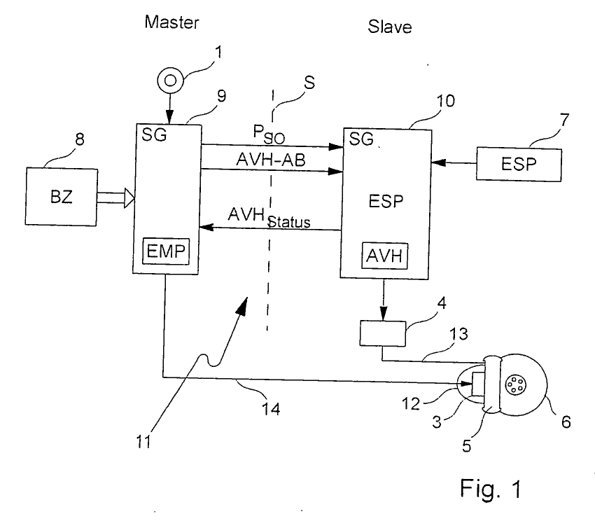

Reference is made to the introductory part hereof regarding the clarification of FIG. 1.

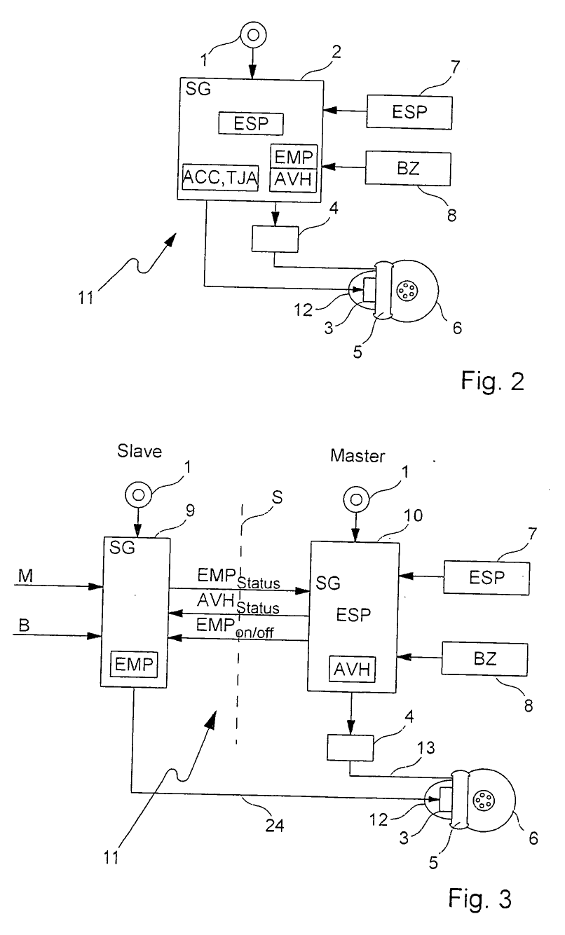

FIG. 2 illustrates a parking brake system 11 having a control unit 2 which is arranged for carrying out both a hold function (AVH) and an arresting function (EMP). To that end, the corresponding functions are stored as program modules AVH, EMP in control unit 2. At the same time, control unit 2 is the control unit for executing an electronic stability program (ESP). From an ESP sensor suite 7, which as a rule includes wheel-speed sensors, an admission-pressure sensor, a steering-wheel angle sensor, a yaw rate sensor and a lateral-acceleration sensor, it receives corresponding signals for executing the electronic stability program. In addition, a sensor suite 8 is provided that supplies control unit 2 with further variables describing the driving condition which may be necessary in order to carry out the AVH, EMP functions of parking brake system 11. For example, sensor suite 8 includes a sensor for detecting the occupancy of the driver's seat or the state of the engine (on/off).

Parking brake system 11 further includes an operating element 1, such as a pressure-operated switch, connected to control unit 2, a hydraulic unit (or pneumatic unit) 4 for actuating a wheel brake 5, as well as an arresting device 12 having an actuator 3 for locking or releasing wheel brake 5. Actuators 3, 4 are connected to control unit 2 via control lines.

In response to a parking-brake request by the driver (by pressing control button 1), ESP control unit 2 triggers a hydraulic pump of hydraulic unit 4 in order to apply pressure to wheel brake 5. After the action is carried out and on condition of a further circumstance, such as the switching off of the vehicle engine or when the driver leaves the vehicle, control unit 2 triggers actuator 3 of arresting device 12 in order to lock wheel brake 5 and retain it in energy-less fashion. For example, actuator 3 may be an electromotor of an electromechanical arresting device or a valve of a hydraulic or pneumatic arresting device.

Hold function AVH and arresting function EMP of parking brake system 11 are stored as corresponding program modules in control unit 2. In this context, the AVH module functions as master module which automatically carries out the hold function in response to the presence of the predefined conditions, and outputs a command to the EMP module in order to carry out the arresting function. The EMP module functions as slave module.

In addition to the program for executing the electronic stability program (ESP), control unit 2 may include further functionalities such as ACC, TJA, etc., for implementing a standstill management.

FIG. 3 illustrates an electrically triggered parking brake system 11 whose functionality (AVH, EMP) is distributed over two control units 9, 10. First control unit 10 is used for triggering hydraulic unit 4 of a hydraulic brake system 4, 5, 13 in order to carry out hold function AVH, and second control unit 9 is used for triggering actuator 3 of arresting device 12 for carrying out the arresting function. Control units 9, 10 are both connected to operating element 1 of parking brake system 11 and communicate with each other via an interface S.

Control units 9, 10 are configured such that, in response to a parking-brake request by the driver, control unit 10 automatically carries out hold function AVH, and under predefined conditions, transmits a request to second control unit 9 (EMP control unit) in order to carry out the arresting function. That is to say, first control unit 10 functions as master control unit, and outputs an EMP request (signal EMP on/off) to EMP control unit 9 which functions as slave control unit and carries out arresting function EMP upon request.

The status of the AVH function is conveyed to EMP control unit 9 by a signal AVHₛₜₐₜᵤₛ. Master control unit 10 receives the status of the EMP function from the signal EMPₛₜₐₜᵤₛ. The transmission of a setpoint pressure or setpoint torque via interface S for carrying out hold function AVH may not be necessary in this configuration.

Master control unit 10 is connected to ESP sensor suite 7, and from a sensor suite 8, also receives information concerning the operating state of the vehicle, which may be necessary for implementing the parking-brake function. On the other hand, EMP control unit 9 may only receive the information which may be necessary for carrying out arresting function EMP, including information M about the operating state of the combustion engine (on/off) and information about the driver's seat occupancy B, from a corresponding sensor suite.

### LIST OF REFERENCE NUMERALS

1 operating element
2 control unit
3 actuator of the arresting device
4 actuator of the wheel brake
5 wheel brake
6 wheel
7 ESP sensor suite
8 operating-state sensor suite
9 second control unit
10 first control unit
11 parking brake system
12 arresting device
13 hydraulic line
14 control line
S interface

1-10. (canceled)

11. An electrically triggered parking brake system for a motor vehicle, comprising:
an operation element adapted to actuate the parking brake system; and
a control unit adapted to trigger an actuator of the parking brake system in response to actuation of the operation element, the control unit arranged as one structural unit and arranged to trigger an actuator to actuate a wheel brake and an actuator to arrest the wheel brake.

12. The system according to claim 11, wherein the control unit is arranged to execute an electronic stability program.

13. The system according to claim 11, wherein the control unit is arranged as a structural unit in which a hold function and an arresting function are stored as program modules.

14. The system according to claim 13, wherein the hold-function program module is arranged as a master module, the arresting-function program module arranged as a slave module.

15. The system according to claim 11, wherein the operation element is connected to the control unit.

16. An electrically triggered parking brake system for a motor vehicle, comprising:
an operation element adapted to actuate the parking brake system;
a first control unit adapted to trigger an actuator to actuate a wheel brake to perform a hold function; and
a second control unit adapted to trigger an actuator of an arresting device to perform an arresting function;
wherein the first control unit is adapted to automatically trigger the actuator of the wheel brake to perform the hold function and to trigger the second control unit to perform the arresting function.

17. The system according to claim 16, wherein the first control unit is adapted to perform an electronic stability program.

18. The system according to claim 16, wherein all information about an operating state of the motor vehicle necessary to perform the hold function is supplied to the first control unit.

19. The system according to claim 18, wherein the first control unit stores at least one further function for performing a braking function.

20. The system according to claim 16, wherein information about at least one of (a) an occupancy of a driver's seat and (b) an operating state of an engine of the motor vehicle is supplied to the second control unit.
